(19) United States
(12) Patent Application Publication
(10) Pub. No.: US 2021/0340310 A1
(43) Pub. Date: Nov. 4, 2021

(54) OXAZOLIDINEDIONE-TERMINATED PREPOLYMER

(71) Applicant: Huntsman International LLC, The Woodlands, TX (US)

(72) Inventors: Ya-Mi Chuang, Lanaken (BE); Giulio Martini, Leuven (BE); Christopher Phanopoulos, Tervuren (BE)

(21) Appl. No.: 17/273,198

(22) PCT Filed: Sep. 5, 2019
(86) PCT No.: PCT/EP2019/073683

§ 371 Date: Mar. 3, 2021

(30) Foreign Application Priority Data
Sep. 10, 2018 (EP) 18193388.8

(51) Int. Cl. C08G 18/80; C08G 18/10; C08G 18/20; C08G 18/76; C08G 18/48; C08G 18/64

(52) U.S. Cl. CPC C08G 18/8064; C08G 18/10; C08G 18/643; C08G 18/7671; C08G 18/4825; C08G 18/2063

(57) ABSTRACT

The present invention relates to a compound obtained by a process comprising the following steps: (i) Reacting at least one isocyanate containing compound, in stoichiometric excess, with a first isocyanate-reactive compound having a number average molecular weight lower than 400, resulting in the formation of at least one prepolymer, (ii) Reacting said prepolymer, in stoichiometric excess, with a second isocyanate-reactive compound having a number average molecular weight equal to or higher than 400, resulting in the formation of a modified prepolymer, (iii) Reacting said modified prepolymer with a hydroxyl-ester compound or a hydroxyl-acid compound with the formation of hydroxyl-ester terminated prepolymer or hydroxyl-acid terminated prepolymer, and Ring-closing said hydroxyl-ester terminated prepolymer or hydroxyl-acid terminated prepolymer; (iv) Formation of said compound made of oxazolidinedione-terminated prepolymer and oxazolidinedione-terminated monomer, which is soluble in said oxazolidinedione-terminated prepolymer.

The present invention relates to oxazolidinedione-terminated prepolymer, poly(urethane-amide) compound, and product comprising said poly(urethane-amide) compound.

Typically, isocyanate containing compounds are reacted with hydroxyl-ester compounds, such as ethyl lactate, in the presence of a catalyst, leading to the formation of urethane-ester compound, which can further be reacted with amine, under condensation reaction conditions. This will result in the formation of poly(urethane-amide) compounds.

Depending on the process/reaction conditions, poly(urethane-amide) compounds will have certain properties, which will define the end uses of the polymer obtained by the process.

Current processes providing amide containing polyurethane polymers are complex, expensive and uncertain regarding the final applications of the final product.

For example, US 2013/0041100 A1 discloses such amide containing polyurethane polymers. In this document, pure 4,4′-diphenyl-methane diisocyanate (4,4′-MDI) is reacted with ethyl lactate, in the presence of a solvent and a catalyst. The reaction product is in solid state—urethane-ester compound. The latter is further reacted with amine, leading to the formation of poly(urethane-amide) compound.

Unfortunately, the reaction between 4,4′-MDI and ethyl lactate is accompanied by side reactions, which causes the formation of ethyl-urethane species. Side reactions should be avoided, since the functionality of the urethane-ester compound is reduced, which results in a lower degree of polymerisation.

This document also discloses the possibility of using a prepolymer in place of the isocyanate containing compound.

However, it has been observed that such prepolymer is directly reacted with ethyl lactate, leading to the formation of urethane-ester compound in solid state. The use of a solvent is thereby necessary, and it increases the number of steps in the process, which is more difficult to manage, since the use of a solvent adversely affects the rest of the process. There is therefore a need to eliminate this solvent, which involves an expensive and complex process.

For the aforementioned reasons, there is a need to provide a compound with higher functionality via a more efficient and simple process.

Unfortunately, as stated above, the known urethane-ester compounds are obtained by complex, expensive and uncertain processes.

It is an object of the invention to overcome the aforementioned drawbacks by providing a compound with higher functionality, which compound can be obtained by a cost-efficient, simpler and convenient process.

In this respect, the present invention provides a compound made of oxazolidinedione-terminated prepolymer and oxazolidinedione-terminated monomer, which compound is obtained by a process comprising, preferably consisting of, the following steps:
(i) Reacting at least one isocyanate containing compound, in stoichiometric excess, with a first isocyanate-reactive compound having a number average molecular weight lower than 400, resulting in the formation of at least one prepolymer having, preferably predominantly, hard blocks in its structure,
(ii) Reacting said at least one prepolymer, in stoichiometric excess, with a second isocyanate-reactive compound having a number average molecular weight equal to or higher than 400, resulting in the formation of a modified prepolymer having soft blocks and hard blocks in its structure, which modified prepolymer contains unreacted isocyanate monomer,
(iii) Reacting said modified prepolymer with a hydroxyl-ester compound or a hydroxyl-acid compound with the formation of hydroxyl-ester terminated prepolymer or hydroxyl-acid terminated prepolymer, and Ring-closing said hydroxyl-ester terminated prepolymer or hydroxyl-acid terminated prepolymer;
(iv) Formation of said compound made of oxazolidinedione-terminated prepolymer and oxazolidinedione-terminated monomer, which is soluble in said oxazolidinedione-terminated prepolymer.

In the present invention, it has been unexpectedly discovered that the compound of the present invention can be obtained by a simpler, less expensive and more efficient process.

The fact that the at least one prepolymer is obtained by using isocyanate-reactive compound with a number average molecular weight less than 400, enables providing a prepolymer with a certain amount of hard blocks content (higher than 80 wt. %, preferably higher than 90 wt. %, more preferably higher than 95 wt. %, based on the total weight of said at least one prepolymer). Then, the modification of such prepolymer with another type of polyol having a number average molecular weight equal to or higher than 400, enables simplifying the process to obtain the compound of the present invention. More precisely, the modified prepolymer of the present invention has soft blocks and hard blocks in its structure and contains unreacted isocyanate monomer.

The combinations between the isocyanate containing compound with the first isocyanate-reactive compound having a number average molecular weight less than 400 and, then the obtained prepolymer with the second isocyanate-reactive compound having a number average molecular weight equal to or higher than 400, provides several advantages to the present invention, in particular easing the process steps with efficiency.

This modified prepolymer is ready to be reacted with hydroxyl-ester compound, such as ethyl lactate, or hydroxyl-acid compound to form hydroxyl-ester terminated prepolymer or hydroxyl-acid terminated prepolymer.

When step (ii) is carried out, the unreacted isocyanate monomer contained in the modified prepolymer and the modified prepolymer should react with the hydroxyl-ester compound or the hydroxyl-acid compound. This means that step (iii) is followed by the formation of the compound of the present invention, which is made of oxazolidinedione-terminated prepolymer and oxazolidinedione-terminated monomer—step (iv).

The compound of the present invention is then ready to be reacted with an amine, to provide poly(urethane-amide) compound having excellent mechanical properties, with the possibility of fine-tuning the properties of the polymer obtained by the process of the present invention, in particular in terms of viscosity.

The advantage of the compound of the present invention is linked to the fact that it is provided in liquid state, since it is ready to be directly used. This is achieved thanks to the fact that the oxazolidinedione-terminated monomer is directly soluble in the oxazolidinedione-terminated prepolymer.

There is therefore no need to add any further steps linked to dissolving the oxazolidinedione-terminated monomer in the final product, obtained in the end of the process.

This technical advantage is achieved, thanks to the fact that modified prepolymer is used in the context of the present invention.

It is therefore more convenient to process it, since it is a compound in liquid state, which enables formation of poly(urethane-amide) compound in a simple way, when mixed with amine, preferably provided in liquid state as well.

Preferably, said compound of the invention has a non-Newtonian viscosity.

In a preferred embodiment of the present invention, said at least one isocyanate containing compound and said first isocyanate-reactive compound are reacted at a molar ratio (NCO:OH) ranging from 1.05 to 200, preferably to 1.5 to 200, more preferably from 2 to 50.

Preferably, said prepolymer and said second isocyanate-reactive compound are reacted at a molar ratio (NCO:OH) ranging from 0.5 to 1.2, preferably from 0.5 to 1.

According to a particular feature of the invention, said at least one prepolymer has an NCO value ranging from 10% to 40%, preferably from 20% to 25%.

Advantageously, said modified prepolymer has an NCO value ranging from 0.5% to 35%, preferably from 0.5% to 30%, more preferably from 0.9% to 25%.

According to a preferred embodiment, step (iii) is performed at a first temperature ranging from 50° C. to 100° C., preferably from 60° C. to 90° C., more preferably from 60° C. to 80° C., resulting in the formation of a hydroxyl-ester terminated prepolymer or a hydroxyl-acid terminated prepolymer.

In particular, step (iii) consists in reacting the modified prepolymer with a hydroxyl-ester compound or hydroxyl-acid compound, in order to create an intermediate product, such as an ethyl-lactate terminated prepolymer. This step is advantageously catalyst free.

Advantageously, step (iii) is carried out, at said first temperature, in a catalyst free condition.

Without being bound to the theory, it is believed that, when step (iii) consists in reacting the modified prepolymer with a hydroxyl-ester compound, such as ethyl lactate, or hydroxyl-acid compound, the release of ethanol can be avoided, and this increases the degree of polymerization by reducing the formation of side-groups. Step (iii) can therefore be performed in an efficient way.

Preferably, step (iii) also comprises a ring-closure step by processing said hydroxyl-ester terminated prepolymer or said hydroxyl-acid terminated prepolymer in the presence of at least one catalyst, at a second temperature, which is preferably higher than said first temperature, resulting in the formation of oxazolidinedione-terminated prepolymer and oxazolidinedione-terminated monomer.

Advantageously, the second temperature ranges from 80° C. to 120° C., preferably from 90° C. to 110° C.

The second temperature can be equal or lower than said first temperature.

The ring-closure step is preferably performed after formation of said intermediate product—hydroxyl-ester terminated prepolymer or said hydroxyl-acid terminated prepolymer- and, more preferably, in the presence of a catalyst.

More specifically, the hydroxyl-ester terminated prepolymer or said hydroxyl-acid terminated prepolymer also contains hydroxyl-ester terminated monomer or hydroxyl-acid terminated monomer, even if not specifically indicated throughout the application.

It has been observed that processing the modified prepolymer with hydroxyl-ester compound or hydroxyl-acid compound at a first temperature, and then the obtained intermediate product at a second temperature, preferably in the presence of a catalyst, enables providing the compound (i.e. oxazolidinedione-terminated prepolymer, wherein oxazolidinedione-terminated monomer is soluble) of the present invention with improved properties.

Preferably, step (iii) of the present invention consists in the following steps:
reacting the modified prepolymer with a hydroxyl-ester compound or hydroxyl-acid compound, in order to create an intermediate product, such as an ethyl-lactate terminated prepolymer (preferably, in catalyst free conditions), and
ring-closing by processing said hydroxyl-ester terminated prepolymer or said hydroxyl-acid terminated prepolymer in the presence of at least one catalyst, at a second temperature, which is preferably higher than said first temperature, resulting in the formation of oxazolidinedione-terminated prepolymer and oxazolidinedione-terminated monomer.

In an advantageous embodiment of the present invention, said catalyst is selected from the group consisting of 1,4-Diazabicyclo[2.2.2]octane (DABCO), 1,8-Diazabicyclo(5.4.0)undec-7-ene (DBU), Triazabicyclodecene (TBD), triethylamine, and potassium t-butanoate.

Preferably, said hydroxyl-ester compound is selected from the group consisting of alpha-hydroxy ester compounds, hydroxyl containing esters derived from fatty acids, natural oils containing hydroxyl groups, and combinations thereof.

In some embodiments, the hydroxyl-ester is an alpha-hydroxyl-ester compound, preferably a lactate, more preferably a lactate selected from the group comprising ethyl lactate, butyl lactate, iso-butyl lactate, propyl lactate, and methyl lactate, yet more preferably said lactate is ethyl lactate.

Preferably, the hydroxyl acid compounds include, but are not limited to, alpha-hydroxy acid. Exemplary hydroxyl acids include, but are not limited to, glycolic acid, 2-hydroxypropionic acid, 2,3-dihydroxypropanoic acid (glyceric acid), 2-hydroxybutyric acid, hydroxybutanedioic acid (malic acid), 2,3-dihyroxybutanedioic acid (tartaric acid), dihydroxypentanoic acid, 2-hydroxypentanedioic acid (alpha-hydroxylglutaric acid), 2-hydroxyhexanic acid. The hydroxyl acid compound can preferably have four or more carbon atoms, citric acid, malic acid, tartaric acid, and the like can be given. As the hydroxyl acid, a citric acid, a tartaric acid and a malic acid may be exemplified.

In the context of the invention, hydroxyl acid compound has preferably at least one hydroxyl group and at least one acidic-functional group, where said least one hydroxyl group is in a position, with respect to said at least one acidic-functional group.

In a particular aspect of the invention, said at least one prepolymer is mainly made of hard blocks.

Said at least one prepolymer has preferably a hard block content of at least 80 wt. %, preferably at least 90 wt. %, more preferably at least 95 wt. %, based on the total weight of said at least one prepolymer.

Advantageously, said modified prepolymer has a hard block content ranging from 2 to 25 wt. %, preferably from 10 to 15 wt. %, based on the total weight of said modified prepolymer.

In a more particular aspect of the invention, said compound of the invention formed in step (iv) has a hard block content ranging from 10 to 15 wt. %, based on the total weight of said compound.

Other embodiments of the compound of the present invention are mentioned in the annexed claims.

The present invention also relates to a poly(urethane-amide) compound obtained by reacting a compound according to the present invention, with at least one amine having a functionality of at least 1.8, preferably of at least 2.

Preferably, the hard block content of the poly(urethane-amide) is at least 5%, preferably at least 10%, preferably at least 15%, preferably at least 20%, preferably at least 25%; preferably the hardblock content is ranging from 5% to 95%.

Other embodiments of the poly(urethane-amide) compound of the present invention are mentioned in the annexed claims.

The present invention further concerns a product comprising poly(urethane-amide) compound according to the present invention.

Other embodiments of the product comprising poly(urethane-amide) compound of the present invention are mentioned in the annexed claims.

The present invention provides a poly(urethane-amide) compound that can be used for the preparation of adhesives, coatings, elastomers, and foams.

According to the invention, step (iii) relates to the reaction between said modified prepolymer of the invention and hydroxyl-ester compound or hydroxyl-acid compound resulting in the formation of an intermediate product. This intermediate product is defined in the present application as hydroxyl-ester terminated prepolymer or as hydroxyl-acid terminated prepolymer.

In the context of the present invention, the “ring-closure step” or “ring-closing” expressions should be understood as a process step, which is applied on the intermediate product obtained in step (iii). The intermediate product is hydroxyl-ester terminated prepolymer or hydroxyl-acid terminated prepolymer, as explained above.

The “ring-closure step” enables forming a compound (as exemplified in scheme B), which is made of oxazolidinedione-terminated prepolymer and oxazolidinedione-terminated monomer, which is soluble in said oxazolidinedione-terminated prepolymer. The final product comprises a 5-membered ring structure, as exemplified in scheme B.

In this context, the compound of the present invention is the final 5-membered-ring product obtained after applying the ring-closure step—referred in the application as step (iv).

Suitable prepolymers are known in the art and commercially available. They are, preferably, the reaction product of an isocyanate containing compound with an isocyanate-reactive compound. Such prepolymers are generally prepared by reacting, in molar excess, of polymeric or pure aromatic isocyanate monomers with one or more polyol(s) using reactive conditions known in the art. The polyols may include aminated polyols, imine or enamine modified polyols, polyether polyols, polyester polyols, polyamines, such as alkanol amines, as well as diols and triols.

Suitable isocyanate containing compound for use in the preparation of the prepolymer may be aromatic, or araliphatic organic isocyanates. Suitable aromatic isocyanates include also polyisocyanates.

Suitable polyisocyanates comprise polyisocyanates of the type Ra—(NCO)x, with x being at least 2 and Ra being an aromatic such as diphenylmethane, or toluene, or a similar polyisocyanate.

Non-limiting examples of suitable aromatic polyisocyanate monomers that can be used in the present invention can be any polyisocyanate compound or mixture of polyisocyanate compounds, preferably wherein said compound(s) comprise(s) preferably at least two isocyanate groups.

Non-limiting examples of suitable aromatic polyisocyanate monomers include diisocyanates, particularly aromatic diisocyanates, and isocyanates of higher functionality.

Non-limiting examples of aromatic polyisocyanate monomers which may be used in the present invention include aromatic isocyanate monomers such as diphenylmethane diisocyanate (MDI) in the form of its 2,4′-, 2,2′- and 4,4′-isomers and mixtures thereof (also referred to as pure MDI), the mixtures of diphenylmethane diisocyanates (MDI) and oligomers thereof (known in the art as “crude” or polymeric MDI), m- and p-phenylene diisocyanate, tolylene-2,4- and tolylene-2,6-diisocyanate (also known as toluene diisocyanate, and referred to as TDI, such as 2,4 TDI and 2,6 TDI) in any suitable isomer mixture, chlorophenylene-2,4-diisocyanate, naphthylene-1,5-diisocyanate, diphenylene-4,4′-diisocyanate, 4,4′-diisocyanate-3,3′-dimethyl-diphenyl, 3-methyl-diphenylmethane-4,4′-diisocyanate and diphenyl ether diisocyanate; tetramethylxylene diisocyanate (TMXDI), and tolidine diisocyanate (TODI); any suitable mixture of these polyisocyanates, and any suitable mixture of one or more of these polyisocyanates with MDI in the form of its 2,4′-, 2,2′- and 4,4′-isomers and mixtures thereof (also referred to as pure MDI), the mixtures of diphenylmethane diisocyanates (MDI) and oligomers thereof (known in the art as “crude” or polymeric MDI), and reaction products of polyisocyanates (e.g. polyisocyanates as set out above, and preferably MDI-based polyisocyanates). Preferably diphenylmethane diisocyanate (MDI) or toluene diisocyanates (TDI)-type isocyanates are used.

In some embodiments, said aromatic isocyanate monomer comprises a polymeric methylene diphenyl diisocyanate. The polymeric methylene diphenyl diisocyanate can comprise any mixture of pure MDI (2,4′-, 2,2′- and 4,4′-methylene diphenyl diisocyanate) and higher homologues of formula (X):

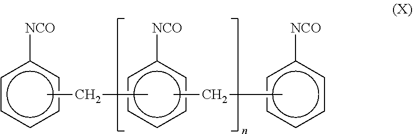

wherein n is an integer which can be from 1 to 10 or higher, preferably does not exclude branched version thereof.

Preferably, the aromatic isocyanate monomer comprises diphenylmethane diisocyanate (MDI), polymeric forms thereof, and/or variants thereof (such as uretonimine-modified MDI).

The isocyanate-reactive compound (first and/or second) may be a component containing isocyanate-reactive groups. As used herein, the term “isocyanate-reactive groups” refers to chemical groups susceptible to electrophilic attack by an isocyanate group.

Non-limiting examples of said groups can be OH. In some embodiments, said isocyanate-reactive compound comprises at least one OH group. Examples of suitable isocyanate-reactive compounds containing isocyanate-reactive OH atoms include polyols such as glycols or even relatively high molecular weight polyether polyols and polyester polyols, carboxylic acids such as polybasic acids.

In some preferred embodiments, the at least one isocyanate-reactive compound is selected from the group comprising hydroxyl terminated polyether (polyether polyols); polyols such as glycols; hydroxyl terminated polyester (polyester polyols); and mixtures thereof, all of which are well known to those skilled in the art.

Suitable hydroxyl terminated polyethers are preferably polyether polyols derived from a diol or polyol having a total of from 2 to 15 carbon atoms, preferably an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and are thus preferred. Useful commercial polyether polyols include poly(ethylene glycol) comprising ethylene oxide reacted with ethylene glycol, poly(propylene glycol) comprising propylene oxide reacted with propylene glycol, poly(tetramethylglycol) (PTMG) comprising water reacted with tetrahydrofuran (THF). Polyether polyols further include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the current invention. Typical copolyethers include the reaction product of glycerol and ethylene oxide or glycerol and propylene oxide.

For the first isocyanate-reactive compound having a number average molecular weight of less than 400 g/mol, suitable hydroxyl terminated polyesters (polyester polyols), can be used, in particular the first isocyanate-reactive compound of the present invention is a mixture of isocyanate-reactive compounds, more preferably a mixture of polyols.

The second isocyanate-reactive compound of the present invention has a number average molecular weight equal to or higher than 400 g/mol, preferably equal to or higher than 500 g/mol. Preferably, polyols have a number average molecular weight equal to or higher than 400 g/mol, preferably equal to or higher than 500 g/mol.

For the second isocyanate-reactive compound having a number average molecular weight equal to or higher than 400 g/mol, more preferably equal to or higher than 500, the various polyethers can have a molecular weight (MW), of at least 500 to at most 20000 g/mol, desirably from at least 600 to at most 10000 g/mol, more preferably of at least 1000 to at most 8000 g/mol, even more preferably from at least 2000 to 6000 g/mol, and most preferably of at least 2000 to at most 4000 g/mol.

The molecular weight is determined by assay of terminal functional groups and is related to the number average molecular weight.

The hydroxyl terminated polyester can be produced by (1) an esterification reaction of one or more glycols with one or more dicarboxylic acids or anhydrides, or (2) by transesterification reaction, i.e. the reaction of one or more glycols with esters of dicarboxylic acids. Mole ratios generally in excess of more than one mole of glycol to acid are preferred so as to obtain linear chains having a preponderance of terminal hydroxyl groups. Suitable polyesters also include various lactones such as polycaprolactone typically made from caprolactone and a bifunctional initiator such as diethylene glycol. The dicarboxylic acids of the desired polyester can be aliphatic, cycloaliphatic, aromatic, or combinations thereof. Suitable dicarboxylic acids which can be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. Adipic acid is the preferred acid. The glycols which are reacted to form a desirable polyester intermediate can be aliphatic, aromatic, or combinations thereof, and have a total of from 2 to 12 carbon atoms, and include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and the like. 1,4-Butanediol is the preferred glycol.

In some embodiments, the isocyanate-reactive compound can be reacted with at least one isocyanate, along with extender glycol. Non-limiting examples of suitable extender glycols (i.e., chain extenders) include lower aliphatic or short chain glycols having from about 2 to about 10 carbon atoms and include, for instance, ethylene glycol, diethylene glycol, propylene glycol, dipropylene glycol, 1,4-butanediol, 1,6-hexanediol, 1,3-butanediol, 1,5-pentanediol, 1,4-cyclohexanedimethanol, hydroquinone di(hydroxyethyl)ether, neopentylglycol, and the like.

Non-limiting examples of suitable catalyst for the ring-closure reaction include 1,4-Diazabicyclo[2.2.2]octane (DABCO), 1,8-Diazabicyclo(5.4.0)undec-7-ene (DBU), Triazabicyclodecene (TBD), triethylamine, and potassium t-butanoate.

Suitable catalysts that may be used in the present invention, include without limitation, tertiary amines, tin-containing compounds, any standard urethane catalyst known in the polyurethane formation art such as triethylene diamine (TEDA), dibutyl tin dilaurate (DBTDL), titanium or zirconium containing compounds (e.g., TYZOR available from DuPont), or combinations thereof. Preferably, the catalyst is present in an amount of at least 10 ppm, preferably at least 0.01% by weight, preferably at least 0.05% by weight, with % by weight based on the total weight of the prepolymer.

In a preferred embodiment, steps (i) and (ii) are performed in a solvent free condition.

Suitable amine compounds that may be used in the present invention include, without limitation, di-functional amines, polyfunctional amines, mixtures of amines or combinations thereof. For example, primary amines, secondary amines, or combinations thereof may be used as the amine compound in the present invention. Preferably primary amines are used. Most preferably primary amine unhindered on the carbon in alpha of the amine. Examples of such amines include, without limitation, those selected from the group consisting of 1,2-ethandiamine, N,N′-bis(3-aminopropyl)methylamine, N,N′-dimethylethylene diamine, neopentanediamine, 4,4′-diaminodiphenyl methane and 2-methylpentamethylenediamine (such as DYTEK A available from Invista, Wilmington, Del., U.S.A.). Additionally, polyetheramines (such as JEFFAMINE polyetheramines available from the Huntsman Corporation, The Woodlands, Tex., U.S.A.), (such as ELASTAMINE HT1100, ECA-29, EDR 148) may be used in the invention, and combination thereof.

The molar ratio between the oxazolidinedione groups of the compound of the invention and primary amine NH₂ can range from 0.8-1.10:1.0-1.10, preferably 0.9-1.05:1.0-1.05 and most preferably 0.95-1.05:1-1.05.

In some embodiments, the reaction with the amine can be conducted at a temperature ranging from 10° C. to 200° C., for example from 25° C. to 150° C., most preferably from 50° C. to 110° C.

If desired, a catalyst can be used to promote the formation of the poly(urethane-amide). Suitable catalysts that may be used include, without limitation, Lewis acids and bases, Bronstead acids and bases, or combinations thereof. Accordingly, suitable catalysts that may be used include, without limitation, DABCO, tin octoate, acetic acid, potassium tert-butoxide, or combinations thereof. While the reactive mixture used to form the poly(urethane-amide) compound described above could be catalyst free, in certain embodiments, a catalyst can be used. In these embodiments, the catalyst can be present in an amount ranging from 0.01 weight % to 10 weight %, such as 0.05 weight % to 1.5 weight %, based on the total weight of the ingredients used.

In some preferred embodiments, the poly(urethane-amide) is thermoplastic. A thermoplastic polymer is a type of plastic that changes properties when heat is applied, e.g., poly(urethane-amide) can melt below 100° C. The material can also be soluble in solvents. Non-limiting examples of such solvents include DMSO, DMF, Toluene, and Acetone.

The poly(urethane-amide) can be incorporated into a variety of compositions that can be used to make various end products. The present invention therefore also encompasses a product comprising the poly(urethane-amide) according to the invention.

Non-limiting list of suitable products comprises adhesives, sealants, coatings, elastomers, foams and the like.

In some embodiments, the product may be an adhesive. In some embodiments, the product may be an elastomer. In some other embodiments, the product may be a foam, such as one component foam. In yet other embodiments, the product may be a coating.

The present invention also relates to a process of manufacturing a compound, which process comprises the following steps:
(i) Reacting at least one isocyanate containing compound, in stoichiometric excess, with a first isocyanate-reactive compound having a number average molecular weight lower than 400, resulting in the formation of at least one prepolymer having hard blocks in its structure,
(ii) Reacting said prepolymer with a second isocyanate-reactive compound having a number average molecular weight equal to or higher than 400, resulting in the formation of a modified prepolymer having soft blocks and hard blocks in its structure, which modified prepolymer contains unreacted isocyanate monomer,
(iii) Reacting said modified prepolymer with a hydroxyl-ester compound or a hydroxyl-acid compound with the formation of hydroxyl-ester terminated prepolymer or hydroxyl-acid terminated prepolymer, and Ring-closing said hydroxyl-ester terminated prepolymer or hydroxyl-acid terminated prepolymer,
(iv) Formation of said compound made of oxazolidinedione-terminated prepolymer and oxazolidinedione-terminated monomer, which is soluble in said oxazolidinedione-terminated prepolymer.

All the features mentioned for the compound obtained by the above mentioned process are also applicable to the process of manufacturing the compound of the invention mentioned here above.

Moreover, and as explained here above, the obtained compound can be reacted with amine to provide poly(urethane-amide) compound. All technical features mentioned for the poly(urethane-amide) compound above apply mutatis mutandis.

In the context of the present invention, at least one isocyanate containing compound is reacted, in stoichiometric excess, with a first isocyanate-reactive compound having a number average molecular weight lower than 400. This reaction step will result in the formation of at least one prepolymer having hard blocks in its structure.

Then, this prepolymer is reacted, in stoichiometric excess, with a second isocyanate-reactive compound having a number average molecular weight equal to or higher than 400, which reaction leads to the formation of a modified prepolymer, which contains unreacted isocyanate monomer.

The modified prepolymer can preferably be reacted with ethyl lactate, preferably in a catalyst free condition.

Preferably, the modified prepolymer (NCO moiety) is contacted with hydroxyl-ester compound, such as ethyl lactate, or hydroxyl-acid compound (hydroxyl moiety), in a stoichiometric ratio of about 1:1, for example from 1.0:2, in order to obtain full end-capping of the isocyanate groups.

Advantageously, it should be noted that the reaction with hydroxyl-ester compound (e.g., ethyl lactate) or hydroxyl-acid compound enables full end-capping of the isocyanate groups (final NCOv equal to 0%) of the modified prepolymer. This reaction is advantageously performed at a first temperature of about 70° C. and leads to the formation of ethyl lactate terminated prepolymer. The latter can further be reacted with a catalyst (ring-closure step), such as DABCO at a second temperature of about 100° C., resulting in the formation of the compound in liquid state of the invention, which is made of oxazolidinedione-terminated prepolymer and oxazolidinedione-terminated monomer, which is soluble in said oxazolidinedione-terminated prepolymer.

This compound in liquid state can further be reacted with amine to provide poly(urethane-amide) compound, having several end uses.

As indicated in the present invention, step (iii) comprises the ring-closure step, which is, preferably performed in the presence of a catalyst.

The term “hard block content of the prepolymer or modified prepolymer” refers to 100 times the ratio of the amount (in part by weight—pbw) of isocyanate+isocyanate-reactive compound having a number average molecular weight less than 400 over the amount (in pbw) of all isocyanates+all isocyanate-reactive compounds used in making the prepolymer.

The term “hard block content of the compound of the present invention” refers to 100 times the ratio of the amount (in pbw) of isocyanate+isocyanate-reactive compound having an average molecular weight less than 400+oxazolidinedione reactive materials having molecular weight of less than 400, over the amount (in pbw) of all isocyanate+oxazolidinedione reactive materials+all isocyanate-reactive materials used.

The term “hard block content of the poly(urethane-amide) compound” refers to 100 times the ratio of the amount (in pbw) of isocyanate+oxazolidinedione ring opened material+isocyanate-reactive compound having molecular weight less than 400+oxazolidinedione reactive compound having molecular weight less than 400+amines having molecular weight less than 400, over the amount (in pbw) of all isocyanates+oxazolidinedione reactive materials+all isocyanate-reactive materials used+all amines used.

The term “soluble” used in the present invention should be understood as meaning that the oxazolidinedione-terminated monomer is visually soluble in the oxazolidinedione-terminated prepolymer. This results in a one-single component, in liquid state. This solubility is visually observed.

As used herein, the term “isocyanate-containing compound” refers to a compound, which comprises at least one isocyanate group (—N═C═O), whereby the isocyanate group may be a terminating group. Preferably, the isocyanate group is a terminating group.

The isocyanate content (NCOv) (also referred to as percent NCO or NCO content) of prepolymers, given in weight %, was measured by conventional NCO titration following the standard ASTM D5155 method. In brief, isocyanate is reacted with an excess of di-n-butylamine to form ureas. The unreacted amine is then titrated with standard nitric acid to the color change of bromocresol green indicator or to a potentiometric endpoint. The percent NCO or NCO-value is defined as the percent by weight of NCO-groups present in the product.

In the context of the present invention, the expression “NCO value” corresponds to an isocyanate value, which is the weight percentage of reactive isocyanate (NCO) groups in an isocyanate containing compound, modified isocyanate or prepolymer and is determined using the following equation, where the molecular weight of the NCO group is 42:

$$Isocyanate value = \% NCO groups = \frac{42 \times Functionality}{Molecular weight} \times 100 .$$

13C-NMR spectroscopy was performed with a Bruker Avance III 500 MHz spectrometer by using a 5 mm probe at room temperature. The prepolymers were measured in acetone-d6, the compound of the invention in DMSO-d6.

FT-IR analyses were performed with a Perkin Elmer 100 FT-IR spectrometer by ATR mode (16 scans, resolution 4 cm-1, 650 to 4000 cm-1 range).

The average molecular weight of the polyol and its distribution were analyzed via gel permeation chromatography (GPC) performed by dissolving the sample in THE (at 5 wt % concentration) and analyzed using a refractive index detector. Detection is based on retention time and is done by use of an UV detector. The Agilent G1310B instrument was equipped with 2× PLgel 5 μm columns (flow rate of 30 ml/min). Area % distribution of prepolymer peaks was given as a result. The obtained chromatogram was contrasted with a polystyrene standard calibration curve.

Young's modulus (kPa), Elongation at break (%), Stress at break (kPa) were measured according to ISO DIN53504. “Dog bone” specimen of the poly(urethane-amide) compound having a cross section of 4×2 mm were strained at 100 mm/min with an Instron device.

The OH value (also referred to as OH number or OH content) can be measured according to the ASTM D1957 standard and is expressed in mg KOH/g.

In the context of the present invention, viscosity can be measured via Rheometrics (a Brookfield R/S-CPS-P2 Rheometer fitted with C25-2 cone spindle at 350 Pa with a cone and plate geometry (CONE SST 20 mm×0.5)), using a shear rate of 100-300 rotation per minute, and a 250-450-micron truncation gap. The viscosity can be measured at ambient temperature 20° C. or higher temperature, e.g., 50° C. or more, if necessary.

### EXAMPLES OF THE INVENTION

The examples described hereunder illustrate some embodiments of the present invention. Unless otherwise indicated, all parts and all percentages in the following examples, as well as throughout the specification, are parts by weight or percentages by weight respectively.

### Example 1

### 1. Preparation of the Modified Prepolymer—Scheme A

250 g of SUPRASEC®2021 (glycol-based diols having a number average molecular weight lower than 400; 0.69 mol, NCOv equal to 23.2%) were weighed out in a round bottomed vessel equipped with mechanical stirrer, digital thermocouple, and water-cooled condenser. The temperature was raised to 70° C. under nitrogen flux. When the reaction temperature was reached, the prepolymer is then reacted with 232.5 g of PPG (Mw=2000 g/mol, OHv=56 mg KOH) (0.5 mol), which were added drop wise to the reaction vessel with a pressure equalized addition funnel under vigorous stirring. The addition rate was controlled, in order to maintain a constant temperature inside the reactor. After the complete addition of PPG 2000, about 6 g of product were sampled to determine the NCO value of the modified prepolymer and to monitor the advancement of the reaction. When the desired NCOv was reached (=10%±0.05%, determined via potentiometric titration as described above under methods), the modified prepolymer, which contains some unreacted MDI, was transferred into metal tins and stored under inert atmosphere at room temperature. The modified prepolymer has a final hard block content of 51.81%.

The hardblock (HB) content (fragments having less than 400 g/mol) was calculated using the following formula:

HB=100×(wt isocyanate+wt chain extender+wt H₂O**−wt CO₂**−wt ethanol)/(wt isocyanate+wt chain extender−wt H₂O**−wt CO₂**−wt ethanol+wt polyol*).

*wt polyol >400 g/mol: soft block only; wt polyol/chain extender <500 g/mol: hardblock.**if no water is added, wt H₂O and wt CO₂ become zero.

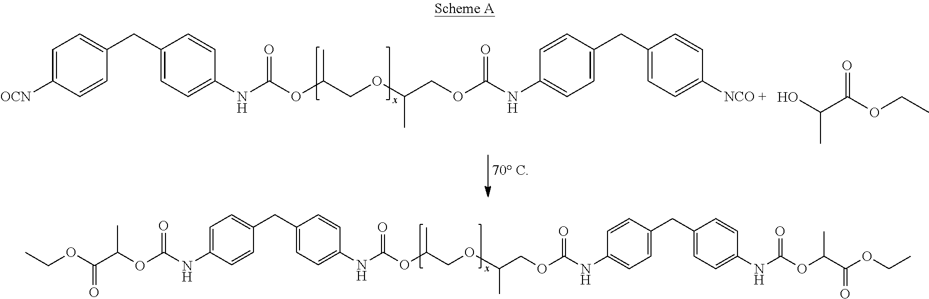

### 2. Reaction with Ethyl Lactate

250 g (0.3 mol) of the prepared modified prepolymer (NCOv equal to about 10%) of section 1 above (SUPRASEC®2021 modified with PPG 2000) were weighted out in a round bottomed flask equipped with mechanical stirrer, digital thermocouple, and condenser. The temperature was raised to 70° C. under nitrogen blanket. When the reaction temperature was reached, an equivalent amount of ethyl lactate, 70.32 g (0.6 mol) was added drop wise to the reaction vessel under mechanical stirring. The viscosity of the mixture (ethyl lactate-terminated prepolymer, which contains ethyl lactate-terminated monomer) was observed, in order to increase, together with the conversion of isocyanate groups to urethane groups. The reaction was followed via infrared spectroscopy analyzing a sample every 30 minutes and monitoring the disappearance of peak associated to the isocyanate groups at 2270 cm-1. When the reaction was completed, the product was transferred into glass bottles and stored under inert atmosphere at ambient temperature.

The ethyl lactate-terminated prepolymer has a final hard block content of 62.38%.

The hardblock (HB) content was calculated using the following formula:

HB=100×(wt isocyanate+wt chain extender+wt ethyl lactate+wt H₂O**−wt CO₂**−wt ethanol)/(wt isocyanate+wt chain extender+wt ethyl lactate+wt H₂O**−wt CO₂**−wt ethanol+wt polyol*).

*wt polyol >400 g/mol: soft block only; wt chain extender/polyol <400 g/mol: hardblock.**if no water is added, wt H₂O and wt CO₂ become zero.

### 3. Synthesis of the Compound of the Present Invention—Ring Closure Step

Under the same condition as indicated for the reaction with ethyl lactate. The reaction product obtained in the above-mentioned step was poured into a 3-neck flask equipped with a Dean-Stark apparatus, thermocouple and mechanical stirrer. DABCO was added (0.05% by weight) and the temperature was raised to 100° C. The intramolecular reaction promotes the formation of ethanol that is distilled out of the reaction vessel. The reaction was monitored via FT-IR following the appearance of a new peak at 1816 cm¹, associated to the stretching of the N—CO bonds in strained rings, the disappearance of the peak at 1726 cm-1 of the esteric C═O in favour of an increased broad peak at 1742 cm-1. When the reaction was completed, the final product was collected in glass bottles without further purification and stored under nitrogen atmosphere.

The compound consists in oxazolidinedione-terminated prepolymer and oxazolidinedione-terminated monomer, where it has been visually observed that oxazolidinedione-terminated monomer is soluble in oxazolidinedione-terminated prepolymer. In this way, the final product is a compound in liquid state.

The oxazolidinedione-terminated prepolymers prepared contained no NCO groups (content below detection limit, as measured by quantitative GC analysis).

The final compound has a final hard block content of 58.86 wt. %.

The hardblock (HB) content was calculated using the following formula:

HB=100×(wt isocyanate+wt chain extender+wt ethyl lactate+wt H₂O**−wt CO₂**−wt ethanol)/(wt isocyanate+wt chain extender+wt ethyl lactate+wt H₂O**−wt CO₂**−wt ethanol+wt polyol*).

*wt polyol >400 g/mol: soft block only; wt chain extender/polyol <400 g/mol: hardblock.**if no water is added, wt H₂O and wt CO₂ become zero.

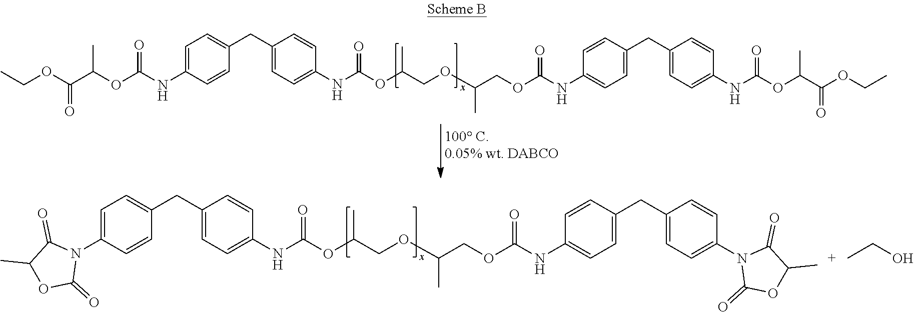

### 4. Synthesis of Poly(Urethane-Amide) Compound

Polymerization of the product obtained in example 1 with amine(s) was carried out as indicated below (see scheme C hereunder).

50 g of the compound of example 1 were weighed out in a disposable glass bottle and heated up to 100° C. under nitrogen blanket. When the viscosity decreased, the compound was stirred with a mechanical mixer. When the reaction temperature was reached, an equimolar amount of primary amine(s) was added (the exact quantities are listed in table 1 below). The mixture was homogenized for 20 seconds and transferred into a mould, pre-heated at 100° C., and allowed to cure for 1 hour.

Please note that different types of amine(s) can be used, as illustrated in table 1 below, including mixtures thereof.

Table 1 below illustrate a first embodiment of example 1 (sample number 1), when compound is reacted with ECA-29 and Elastamine HT 1100 at a certain amount respectively, and a second embodiment, when the compound of example 1 is reacted with ECA-29 and Elastamine HT 1100 in amounts, as indicated below.

TABLE 1

| | | | | | | FINAL POLYMER | SAMPLE |
|---|---|---|---|---|---|---|---|
| COMPOUND OF THE INVENTION | | | AMINES | | | HARDBLOCK | NUMBER |
| S2021/PPG 2000 FINAL | 50 G | 0.049 MOL | ECA-29 | 9.21 G | 0.034 MOL | 51% | 1 |
| NCOv 10% | | | ELASTAMINE | 16.50 G | 0.015 MOL | | |
| | | | HT 1100 | | | | |
| S2021/PPG 2000 FINAL | 50 G | 0.049 MOL | ECA-29 | 12.47 G | 0.046 MOL | 64% | 2 |
| NCOv 10% | | | ELASTAMINE | 3.30 G | 0.003 MOL | | |
| | | | HT 1100 | | | | |

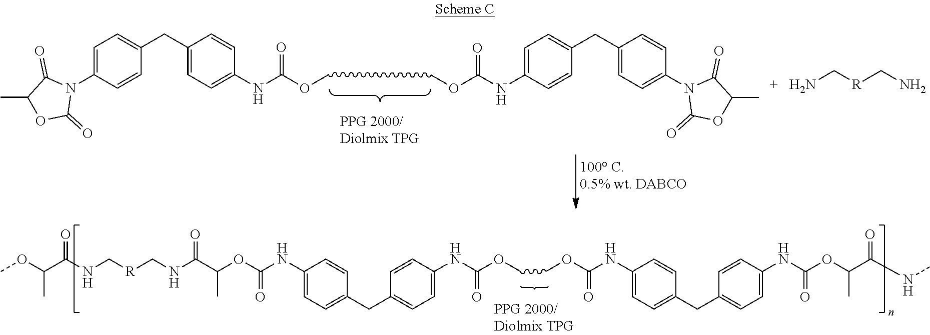

### 5. Mechanical Properties

### Example 1

The cured polymers were cut into “dog bone” specimen in order to evaluate their tensile mechanical properties. The selected geometry has a cross section of 4×2 mm. The specimens were strained at 100 mm/min with an Instron device (ISO DIN53504). The results are shown in table 2.

Table 2 here below illustrates mechanical properties of the poly(urethane-amide) of example 1, according to the first and second embodiment.

TABLE 2

| | Hard block | Young's | Elongation | Stress |
|---|---|---|---|---|
| | content in % | modulus | at break | at break |
| Product | (after cure) | (kPa) | (%) | (kPa) |
| Poly(urtheane-amide) | 51 | 1415 | 971 | 911 |
| compound_sample 1 | | | | |
| of example 1 | | | | |
| Poly(urtheane-amide) | 64 | 3251 | 175 | 1334 |
| compound_sample 2 | | | | |
| of example 1 | | | | |

### Example 2

All the aforementioned conditions and compounds were applied for example 2, except that the modified prepolymer of example 2 was obtained by using 106.82 g of PPG 2000 with 250 g of SUPRASEC®2021, in order to obtain a final NCOv of about 15%. Moreover, the final hard block content of such modified prepolymer was 70.06%.

Moreover, the modified prepolymer of example 2 is reacted with ethyl lactate as indicated above, resulting in the formation of the compound of the invention, which is then further reacted with amine (table 3 below), according to a first (sample number 3), second (sample number 4) and third (sample number 5) embodiments of example 2.

TABLE 3

| OXAZOLIDINEDIONE-TERMINATED | | | | | | FINAL POLYMER | SAMPLE |
|---|---|---|---|---|---|---|---|
| PREPOLYMER | | | AMINES | | | HARDBLOCK | NUMBER |
| S2021/PPG 2000 FINAL | 50 G | 0.071 MOL | ECA-29 | 11.11 G | 0.041 MOL | 52% | 3 |
| NCOv 15% | | | ELASTAMINE | 33.00 G | 0.030 MOL | | |
| | | | HT 1100 | | | | |
| S2021/PPG 2000 FINAL | 50 G | 0.071 MOL | ECA-29 | 14.91 G | 0.055 MOL | 64% | 4 |
| NCOv 15% | | | ELASTAMINE | 17.60 G | 0.016 MOL | | |
| | | | HT 1100 | | | | |
| S2021/PPG 2000 FINAL | 50 G | 0.071 MOL | ECA-29 | 19.24 G | 0.071 MOL | 83% | 5 |
| NCOv 15% | | | | | | | |

### Mechanical Properties

### Example 2

The cured polymers were cut into “dog bone” specimen in order to evaluate their tensile mechanical properties. The selected geometry has a cross section of 4×2 mm. The specimens were strained at 100 mm/min with an Instron device (ISO DIN53504). The results are shown in table 4.

Table 4 here below illustrates mechanical properties of the poly(urethane-amide) of example 2, according to the first and second embodiments.

TABLE 4

| | Hard block | Young's | Elongation | Stress |
|---|---|---|---|---|
| | content | modulus | at break | at break |
| Product | (%) | (kPa) | (%) | (kPa) |
| Poly(urethane-amide) | 52 | 200 | 298 | 88 |
| compound- sample 3 | | | | |
| of example 2 | | | | |
| Poly(urethane-amide) | 64 | 1112 | 19 | 1077 |
| compound- sample 4 | | | | |
| of example 2 | | | | |

For all of the above-mentioned examples and embodiments, the obtained polymers did not need any purification and could be synthesized with different hard block contents by combining different amines.

### COMPARATIVE EXAMPLE 1

300 g of xylenes were added to a 500 mL three-neck, round bottom flask. This flask was dropped into a 75° C. oil bath and an overhead stirring apparatus was attached. 150 mg (0.1 wt %) of DABCO catalyst and 75 g ethyl lactate were then added to this solution. Finally, 75 g of RUBINATE 44, from a ‘melted out’ stock supply in an 80° C. oven, was poured into an addition funnel connected to one of the flask's necks. A heat gun was used to prevent RUBINATE 44 recrystallization. The addition funnel's contents were then added drop wise over a 15-minute period. Attenuated Total Reflectance Fourier Transform Infrared Spectroscopy (from Thermo Fisher Scientific) was used to track the intensity reduction of the isocyanate peak, seen at approximately 2250 cm-1. Significant reduction was seen after 2.25 hours. At that point, the flask was removed from the oil bath and allowed to cool to room temperature. During this cooling, precipitation occurred resulting in the formation of a white solid. This could be promoted by placing the flask in an ice bath to further decrease the product's solubility in xylenes. The product was isolated by vacuum filtration over a three-day period.

Then, 13.8 g of JEFFAMINE D2000 and 11.1 g of JEFFAMINE D400 (from Huntsman) were poured into an 8 oz. jar making a 2:8 blend. The jar was then placed in a 100° C. oil bath and an overhead mixing apparatus was established. Afterwards, 0.41 mL tin octoate catalyst (a 1.25 wt % loading) was added to the blend. Finally, 16 g of the urethane-ester synthesized above (Rubinate 44/Ethyl Lactate adduct) was added. The (poly) urethane-amide compound was formed by stirring and heating the reactive mixture for a period of five hours.

Table 5 hereunder indicates the types of products used in the examples of the present invention.

TABLE 5

| CHEMICAL NAME | TRADE NAME | CAS | SUPPLIER | CHEMICAL STRUCTURE OF KEY COMPONENTS |
|---|---|---|---|---|
| Poly(propylene glycol) (PPG 2000) Mw 2000 g/mol | Acclaim 2200 | 25322-69-4 | Covestro | 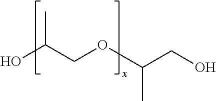 |
| Diphenylmethane 4,4′- | SUPRASEC ® | N.A | Huntsman | |
| diisocyanate/TPG- | 2021 | | | |
| diolmix prepolymer | | | | |
| (chain extender/polypol | | | | |
| with Mn below 400 g/mol) | | | | |
| Ethyl Lactate | Ethyl Lactate | 687-47-8 | Sigma- Aldrich | 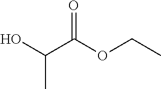 |
| 1,4-Diazabicyclo[2.2.2]- octane | DABCO | 280-57-9 | Sigma- Aldrich | 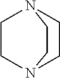 |
| Polyethylenepolyamine: chain extender molecular weight MW below 400 g/mol (about 271 g/mol) | ECA-29 | 68131-73-7 | Huntsman | 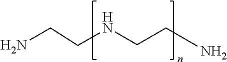 |
| Polyetrahydrofuran diamine | Elastamine HT 1100 | 72088-96-1 | Huntsman | 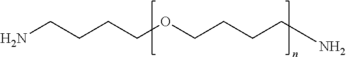 |

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

As used herein, the singular forms “a”, “an”, and “the” include both singular and plural referents unless the context clearly dictates otherwise. By way of example, “an isocyanate group” means one isocyanate group or more than one isocyanate group.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”. This means that, preferably, the aforementioned terms, such as “comprising”, “comprises”, “comprised of”, “containing”, “contains”, “contained of”, can be replaced by “consisting”, “consisting of”, “consists”.

Throughout this application, the term “about” is used to indicate that a value includes the standard deviation of error for the device or method being employed to determine the value.

As used herein, the terms “% by weight”, “wt %”, “weight percentage”, or “percentage by weight” are used interchangeably.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

All references cited in the present specification are hereby incorporated by reference in their entirety. In particular, the teachings of all references herein specifically referred to are incorporated by reference.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

Throughout this application, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Although the preferred embodiments of the invention have been disclosed for illustrative purpose, those skilled in the art will appreciate that various modifications, additions or substitutions are possible, without departing from the scope and spirit of the invention as disclosed in the accompanying claims.

1. A compound obtained by a process comprising the following steps:
(i) Reacting at least one isocyanate containing compound, in stoichiometric excess, with a first isocyanate-reactive compound having a number average molecular weight lower than 400, resulting in the formation of at least one prepolymer having hard blocks in its structure,
(ii) Reacting said prepolymer, in stoichiometric excess, with a second isocyanate-reactive compound having a number average molecular weight equal to or higher than 400, resulting in the formation of a modified prepolymer having soft blocks and hard blocks in its structure, which modified prepolymer contains unreacted isocyanate monomer
(iii) Reacting said modified prepolymer with a hydroxyl-ester compound or a hydroxyl-acid compound with the formation of hydroxyl-ester terminated prepolymer or hydroxyl-acid terminated prepolymer, and
Ring-closing said hydroxyl-ester terminated prepolymer or hydroxyl-acid terminated prepolymer, and
(iv) forming of said compound made of oxazolidinedione-terminated prepolymer and oxazolidinedione-terminated monomer, which is soluble in said oxazolidinedione-terminated prepolymer.

2. The compound according to claim 1, wherein said at least one isocyanate containing compound and said first isocyanate-reactive compound are reacted at a molar ratio (NCO:OH) ranging 1.05 to 200, preferably to 1.5 to 200.

3. The compound according to claim 1, wherein said prepolymer and said second isocyanate-reactive compound are reacted at a molar ratio (NCO:OH) ranging from 0.5 to 1.2.

4. The compound according to claim 1, wherein said at least one prepolymer has an NCO value ranging from 10% to 40%, preferably from 20% to 25%.

5. The compound according to claim 1, wherein said modified prepolymer has an NCO value ranging from 0.5% to 35%.

6. The compound according to claim 1, wherein step (iii) is performed at a first temperature ranging from 50° C. to 100° C. resulting in the formation of a hydroxyl-ester terminated prepolymer or a hydroxyl-acid terminated prepolymer.

7. The compound according to claim 6, wherein step (iii) is carried out, at said first temperature, in a catalyst free condition.

8. The compound according to claim 6, wherein step (iii) comprises a ring-closure step by processing said hydroxyl-ester terminated prepolymer or a hydroxyl-acid terminated prepolymer in the presence of at least one catalyst, at a second temperature, which is preferably higher than the first temperature, resulting in the formation of oxazolidinedione-terminated prepolymer and oxazolidinedione-terminated monomer.

9. The compound according to claim 1, wherein said at least one prepolymer has a hard block content of at least 80 wt. %.

10. The compound according to claim 1, wherein said modified prepolymer has a hard block content ranging from 2 to 25 wt.

11. The compound according to claim 1, wherein said compound formed in step (iv) has a hard block content ranging from 10 to 15 wt. %.

12. A poly(urethane-amide) compound obtained by reacting a compound according to claim 1, with at least one amine compound having a functionality of at least 1.8.

13. A product comprising poly(urethane-amide) compound according to claim 12.
